(19) United States
(12) Patent Application Publication
(10) Pub. No.: US 2022/0356619 A1
(43) Pub. Date: Nov. 10, 2022

(54) MOISTURE ABSORBING FABRRIC BLEND

(71) Applicants: John Garner, Lawsonville, NC (US); Brian Babcock, Columbia, TN (US); Gilbert Patrick, Kings Mountain, NC (US); David Gray, St. Paul, MN (US)

(72) Inventors: John Garner, Lawsonville, NC (US); Brian Babcock, Columbia, TN (US); Gilbert Patrick, Kings Mountain, NC (US); David Gray, St. Paul, MN (US)

(21) Appl. No.: 17/472,621

(22) Filed: Sep. 11, 2021

Related U.S. Application Data
(63) Continuation-in-part of application No. 17/246,664, filed on May 2, 2021.

(51) Int. Cl. D04H 1/732; D04H 1/435; D04H 1/425

(52) U.S. Cl. CPC D04H 1/732; D04H 1/435; D04H 1/425; D10B 2331/04; D10B 2401/022; D10B 2401/041; D10B 2401/061; D10B 2201/00

(57) ABSTRACT

A moisture-retentive fabric medium includes a hydrophilic, thermoplastic polyester fiber as a blend of from 10-905% or 20-80% by total weight of textile fibers and 90-10% or 80-20% by total weight of hydrophilic textile fibers and less than 0.5% by weight of total fabric medium as microfibrillated cellulose fiber and less than 0.05% by weight superabsorbent polymers, the polyester having a melting point between 190-500 F when measured in accordance with ASTM D-3418.

### RELATED APPLICATION DATA

This application claims priority under 35 U.S.C. 120 as a continuation-in-part Application of U.S. Ser. No. 17/246,664, filed 2 May 2021 (Babcock) titled “HIGH PARTICLE CAPTURE MOISTURE ABSORBING FABRIC.”

### BACKGROUND OF THE INVENTION

### 1. Field of the Invention

The present invention relates to fabric blends, especially blended fiber fabric materials woven, knitted or mechanically combined (e.g., using yarns or twisted filaments) and even some non-woven fabric blends, and non-woven fabric blends with a controlled level of moisture absorbance.

### 2. Background of the Art

In recent years, the prevalence of nosocomial infections has had serious implications for both patients and healthcare workers and the severity of airborne diseases brought into medical care facilities (including clinics, hospitals and long-term care homes) has reached a level of concern for health care workers. Such significant airborne diseases include at least COVID-19, SARS, H1N1 virus, and mutations in seasonal viruses. Nosocomial infections are those that originate, persist or occur in a hospital, long-term care facility, or other health care setting, and are sometimes referred to as “hospital associated infections” or HAI. In general, nosocomial infections are more serious and dangerous than external, community-acquired infections because the pathogens in hospitals are more virulent and tend to be more resistant to typical antibiotics. These HAIs are usually related to a procedure or treatment used to diagnose or treat the patient's illness or injury and may be spread by indirect, inadvertent contact. Published U.S. Patent Application Document 2007/0044801 and Published U.S. Patent Application Document 2007/0141126 and U.S. Pat. No. 4,856,509 disclose face masks containing antimicrobial ingredients that are used as a first barrier against inhalation of such diseases, usually viruses. Bacterial infections are also becoming significant issues, with Methicyllin Resistant Strep A (MRSA) becoming a major health issue, although this is usually spread by contact rather than inhalation.

Infection control has been a formal discipline in the United States since the 1950s, due to the spread of staphylococcal infections in hospitals. Because there is both the risk of health care providers acquiring infections themselves, and of them passing infections on to patients, the Centers for Disease Control and Prevention have established guidelines for infection control procedures. In addition to hospitals, infection control is important in nursing homes, clinics, physician offices, child care centers, and restaurants, as well as in the home. The purpose of infection control in hospital and clinical environments is to reduce the occurrence of infectious diseases. These diseases are usually caused by bacteria or viruses and can be spread by human to human contact, animal to human contact, human contact with an infected surface, airborne transmission, and, finally, by such common vehicles as food or water. The use of medical devices such as gloves, gowns, and masks as barriers to pathogens is already well appreciated by infection control practitioners. It is apparent by the increase in antibiotic resistance and the persistence of HAIs, however, that these practices alone are not enough.

Hospitals and other healthcare facilities have developed extensive infection control programs to prevent nosocomial infections. Even though hospital infection control programs and a more conscientious effort on the part of healthcare workers to take proper precautions when caring for patients can prevent some of these infections, a significant number of infections still occur. Therefore, the current procedures are not sufficient. Despite enforcement of precautionary measures (e.g. washing hands, wearing gloves, face mask and cover gowns), contact transfer is still a fundamental cause of HAIs. That is, individuals who contact pathogen-contaminated surface such as table tops, bed rails, hands, clothing and/or medical instruments, can still transfer the pathogens from one surface to another immediately or within a short time after initial contact. To improve this situation, a standard device or article can be enhanced for infection control by addition of actives that can kill pathogens when they come in contact with the article or can bind the pathogen such that dispersal is not possible. One problem with masks is that they tend to concentrate microbes on the surface of the mask, and even where antimicrobial activity is provided with the mask, that activity tends to be internal and slow acting, and diminishes over time, allowing microbial buildup on the mask surface. Therefore when the mask is contacted, even for removal, the user can pick up concentrated microbes on their hands and spread them to others, other surfaces and to themselves.

In the COVID-19 pandemic beginning in 2020, one of the most effective methods of reducing the rate of spread of the virus is the universal use of effective filtering masks by the population whenever persons are within 20 feet of each other. The use of masks by all persons in contact over a twenty-minute period can reduce microbial transfer between wearers by more than 80% with both persons wearing effective filtering masks. To be effective, the masks must filter moisture droplets out of the air, retain the droplets, not redisperse the droplets, and preferably attack any microbes brought into the mask by the filtration of air by the breathing pattern of the user.

U.S. Pat. No. 10,182,946 (Gray) is an example of a high quality mask material that can meet these goals. A filter material entraps particles and actively affects the trapped particles within the filter. The fabric has a blend of hydrophilic superabsorbent fibers and non-superabsorbent hydrophilic fibers that is sufficiently porous as to allow gaseous flow through the fabric. The fabric having a thickness and the fabric has as a coating of a mixture of a chemically or physically active compound and a liquid carrier forming an active composition on both the outer surface of the hydrophilic superabsorbent fibers, and the hydrophilic superabsorbent fibers have a central volume also retaining the active composition. The central volume of the hydrophilic superabsorbent fibers acting as a reservoir for replacement of the active compound into the coating when concentration of active compounds in the coating are reduced to a concentration less than concentrations of the active compound within the central volume; and the liquid carrier is an aqueous liquid.

U.S. patent application Ser. No. 17/246,664, filed 2 May 2021 (Babcock) titled “HIGH PARTICLE CAPTURE MOISTURE ABSORBING FABRIC” discloses a gas filtering medium is provided with hydrophobic polyester fiber as from 20-80% by total weight of textile fibers and 80-20% by total weight of hydrophilic textile fibers and a microfibrillated cellulose fiber (MCF or MFC) in a weight/weight ratio of 1.5-8.5/100 parts by weight of total textile fiber. The addition of the MCF increases particle filtration properties while maintain good fabric properties.

U.S. Pat. No. 8,642,833 (Waxman) evidences a reusable absorbent article includes a hydrophilic top layer, a soaking layer adjacent to and beneath the top layer, a substantially liquid impermeable layer adjacent to and beneath the soaking layer, and a backing layer adjacent to and beneath the substantially liquid impermeable layer. All of the layers are secured together to form a unitary structure. The soaking layer is a non-woven fabric having a plurality of hydrophobic fibers of a generally circular cross-sectional shape and a plurality of hydrophilic fibers of a non-circular cross-sectional shape. A second or intermediate absorbent layer is disposed adjacent to and beneath or below the top layer. In particular, a top surface of the second layer is directly in contact with a second or bottom surface of the top layer. The second layer is an absorbent layer that functions as a distribution or soaking layer, for absorption, containment and distribution of liquid. The soaking layer has a thickness of approximately 2.5-3.0 millimeters, and a mass per unit area of 350 grams per square meter. The soaking layer is preferably made of a non-woven needle punch fabric and comprises a plurality of hydrophobic fibers and a plurality of hydrophilic fibers. The hydrophobic fibers are preferably polyester fibers and have a generally circular cross-sectional shape. The hydrophilic fibers, on the other hand, are shaped fibers, meaning they have a non-circular cross-sectional shape, and are preferably made of a polyester resin. The hydrophilic shaped fibers have a denier of approximately 3.0 and, more preferably, of 2.78, a length of approximately 3-5 centimeters and a diameter of approximately 4-5 microns. Preferably, the soaking layer comprises approximately 60-65% polyester hydrophobic fibers and 35-40% hydrophilic fibers. The polymers described, such as polyester, also includes copolymers of those materials, and with polyesters, these are often referred to as copolyesters (coPolyesters).

Further advances in fabric materials for these types of masks, gowns, room filters, machine filters and the like are still desirable.

### SUMMARY OF THE INVENTION

A moisture-retentive fabric medium comprising a first hydrophilic, thermoplastic elastomeric polyester fiber as a blend of from 20-80% by total weight of the thermoplastic elastomeric polyester textile fibers and a second fiber comprising 80-20% by total weight of hydrophilic textile fibers, the thermoplastic hydrophilic polyester fiber having a melting point between 190-500 F.

A gas filtering medium is provided with hydrophobic polyester fiber (including copolyester fibers) as from 10-90% or 20-80% by total weight of textile fibers and 90-10% or 80-20% by total weight of hydrophilic textile fibers and less than 0.5% by weight of superabsorbent polymers and preferably less than 1.0/100 parts by weight of total textile fibers of a microfibrillated cellulose fiber (MCF or MFC). A preferred material is an aromatic polyester such as tetramethylene terephthalate and the aliphatic polyether is alkylene ether glycol. Specifically, polybutylene terephthalate/polytetramethylene ether glycol block copolymer can be mentioned for instance. Specifically, a commercialized product is manufactured and marketed under the trade names, such as HYTREL™ (trade name, manufactured by E. I. du Pont de Nemours & Company (Inc.)).

### BRIEF DESCRIPTION OF THE FIGURES

FIG. 1 shows a chart of water retention properties for all samples, both invention and comparative.

FIG. 2 shows a chart for water retention properties for six (6) different non-woven blends of fibers.

FIG. 3 shows a chart of water retention properties for non-woven blends of fibers with and without microfibrillated cellulose.

FIG. 4 shows a chart of water retention properties for non-woven blends of fibers with Blend A.

FIG. 5 shows a chart of water retention properties for non-woven blends of fibers with Blend B.

FIG. 6 shows a chart of water retention properties for non-woven blends of fibers with Blend C.

FIG. 7 shows a graph of water retention properties for all samples, both invention and comparative.

FIG. 8 shows a graph of water retention properties for all samples of non-woven fabric.

FIG. 9 shows a graph of water retention properties for six (6) different non-woven blends of fibers.

FIG. 10 shows a graph of water retention properties for non-woven blends of fibers with and without microfibrillated cellulose.

FIG. 11 shows a graph of water retention properties for non-woven blends of fibers with Blend A.

FIG. 12 shows a graph of water retention properties for non-woven blends of fibers with Blend B.

FIG. 12 shows a graph of water retention properties for non-woven blends of fibers with Blend C.

FIG. 13 shows a graph of fractional efficiency (filtration) properties for all samples of non-woven fabric.

FIG. 14 shows a graph showing fractional efficiency at 10 ft//minute for fiber blends without microfibrillated cellulose as Efficiency versus Particle Diameter.

FIG. 15 shows a graph showing fractional efficiency at 10 ft//minute for the “Media” fiber Blend A with two different levels (2% and 5%) of microfibrillated cellulose as Efficiency versus Particle Diameter.

FIG. 16 shows a graph showing fractional efficiency at 10 ft//minute for Media Blend A as Efficiency versus Particle Diameter.

FIG. 16 shows a graph showing fractional efficiency at 10 ft//minute for Media Blend B as Efficiency versus Particle Diameter.

FIG. 16 shows a second graph showing fractional efficiency at 10 ft//minute for Media Blend A microfibrillated cellulose as Efficiency versus Particle Diameter.

FIG. 17 is a second graph showing fractional efficiency at 10 ft//minute for Media Blend A as Efficiency versus Particle Diameter.

FIG. 18 shows a graph showing fractional efficiency at 10 ft//minute for Media Blend C as Efficiency versus Particle Diameter.

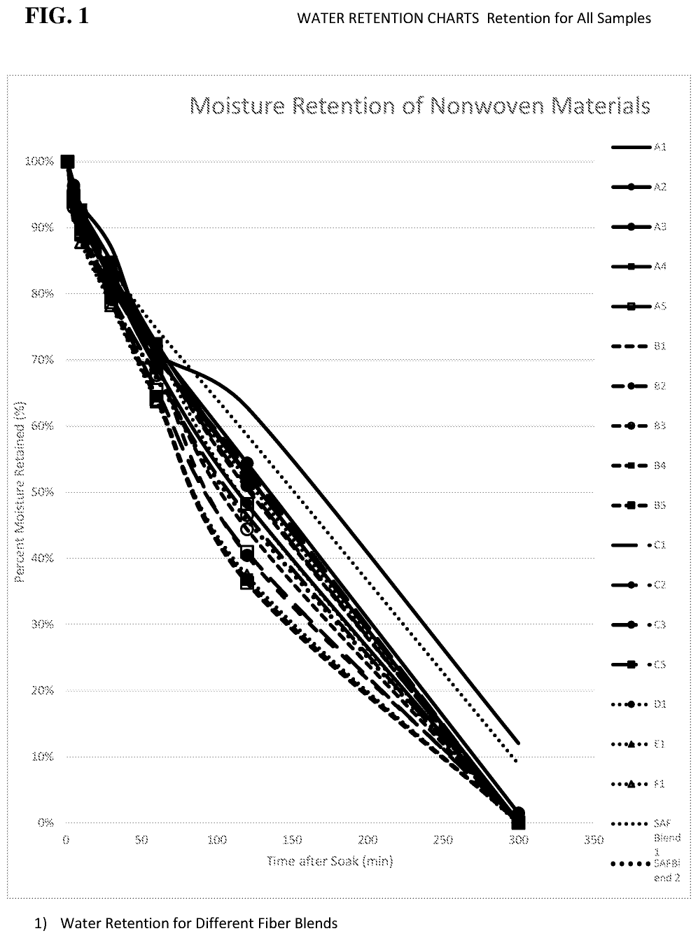

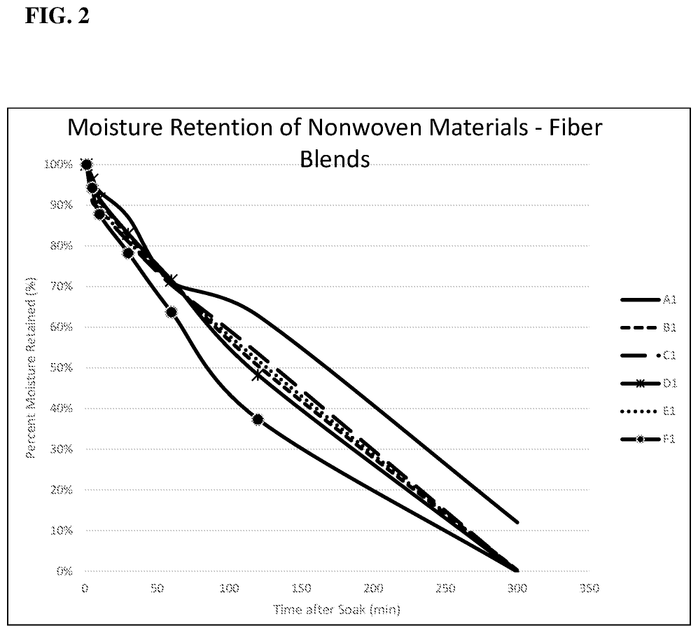

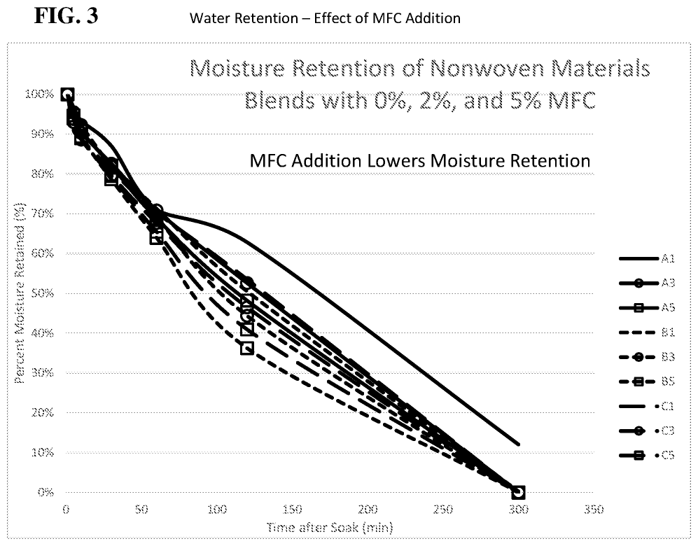

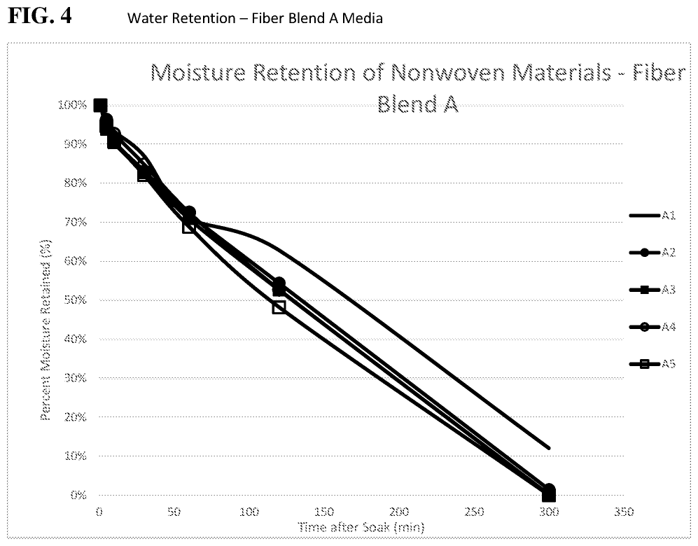

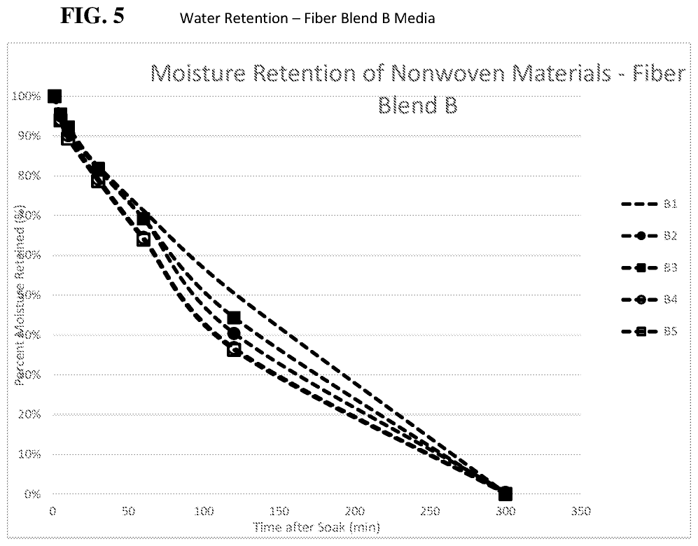

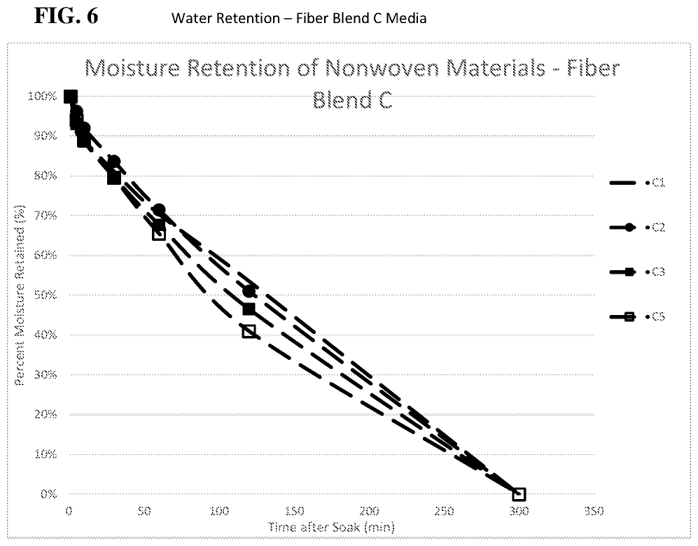

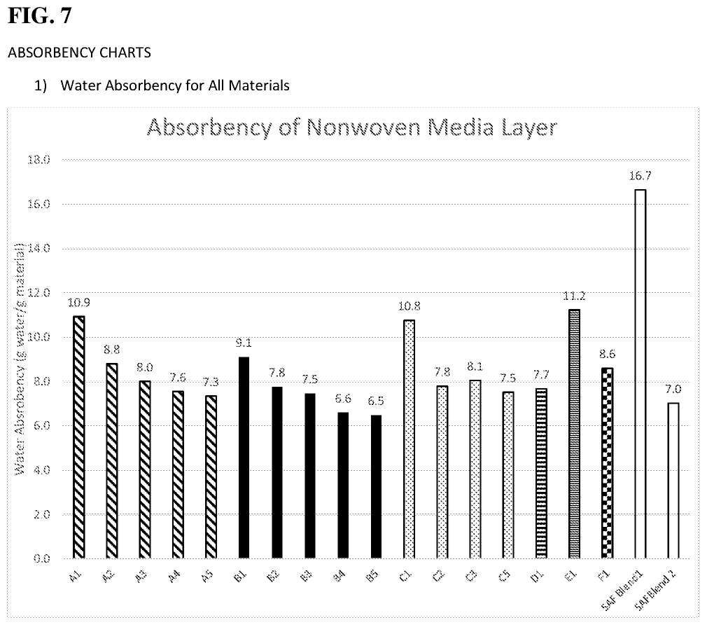

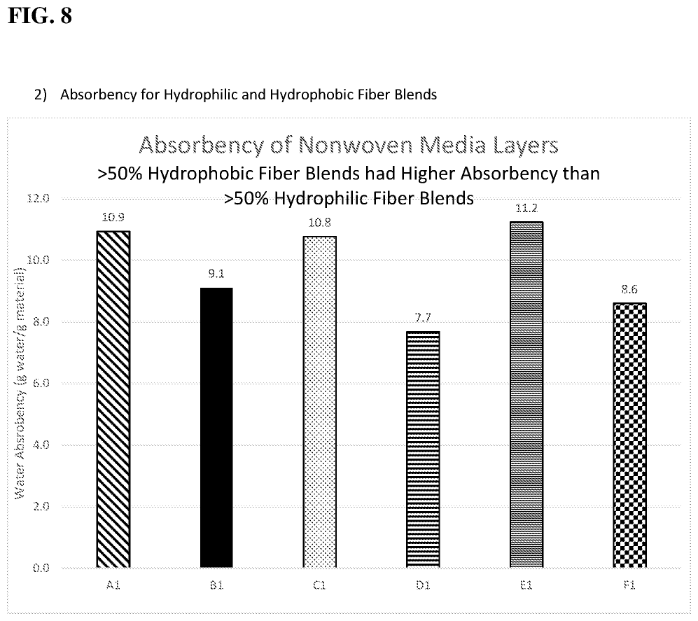

### DETAILED DESCRIPTION OF THE INVENTION

A water-absorbent fabric, particularly useful for athletic and comfort wear includes a hydrophobic polyester fiber (including copolyester materials) as from 20-80% by total weight of textile fibers and 80-20% by total weight of hydrophilic textile fibers. The water-absorbent medium may be a woven, knitted, layered, non-woven fabric, and especially a structured fabric using yarns or twisted filaments of the respective fibers. Hydrophilic is typically defined as a surface characteristic in which a fiber has a contact angle with deionized water at 20 C and 1 atmosphere of pressure of less than 90 degrees. The lower the contact angle, such as 85 degrees or 80 degrees at these conditions, the more hydrophilic he fiber.

A moisture retentive fabric described herein may include 20-80% by total weight of fibers as a water-absorbent thermoplastic elastomeric copolyester derived from aliphatic alkylene glycols or branched aliphatic glycols and having a water absorption of 15-0% (by weight) of the copolyester, and the copolyester fibers are blended with a second fiber comprising 80-20% by total weight of fibers as hydrophilic textile fibers.

The moisture retentive fabric described above may further and more narrowly be described as having 20-80% by total weight of fibers as a thermoplastic elastomeric copolyester derived from aliphatic alkylene glycols or branched aliphatic glycols having from 3-12 carbon atoms and having the empirical formula HO—CₙH₂ₙ—OH, where n is an integer from 3-12; cis or trans-1,4-cyclohexanedimethanol or mixtures thereof; triethylene glycol; 2,2-bis[4-(2-hydroxyethoxy)phenyl]propane; 1,1-bis[4-(2-hydroxyethoxy)-phenyl]cyclohexane; 9,9-bis[4-(2-hydroxyethoxy)phenyl]fluorene; 1,4:3,6-dianhydromannitol; 1,4:3,6-dianhydroiditol; or 1,4-anhydroerythritol, and the copolyester fibers are blended with a second fiber comprising 80-20% by total weight of fibers as hydrophilic textile fibers.

The technology of the present invention may include a moisture-retentive fabric medium with a first hydrophilic, thermoplastic polyester fiber as a blend of from 20-80% by total weight of the thermoplastic polyester textile fibers and a second fiber as about 80-20% by total weight of hydrophilic textile fibers and a less than 0.5% by weight of total fabric medium as microfibrillated cellulose fiber and less than 0.05% by weight superabsorbent polymers, the thermoplastic hydrophilic polyester fiber having a melting point between 190-500 F when measured in accordance with ASTM D-3418. The polyester may be present as a polyetherester.

The polyester may have a melt flow rate of from 3.5 to 9.0 grams per 10 minutes when measured in accordance with ASTM D-1238 at 190 degrees C. under a 2,160 gram load and a melting point of from 275 degrees F. to 425 degrees F. when measured in accordance with ASTM D-3418; a specific gravity of from about 1.10 to 1.20 when measured in accordance with ASTM D-792; and a tensile stress at break, with a head speed 2 inches per minute of from 1,800 psi to about 4,500 psi when measured in accordance with ASTM D-638.

The polyester may have an elongation at break of from 200 percent to 600 percent when measured in accordance with ASTM D-638 and a flexural modulus at 212 degrees F. of about 3,500 psi to 10,000 psi. The moisture-retentive fabric medium may have the medium include a yarn consisting essentially of the blend of at least two fibers. A third fiber may be included for adding additional properties into the yarn as a component fiber, twisted fiber or yarn known in the art. The moisture-retentive fabric medium may consist essentially of the two fibers as the yarn consisting essentially of the blend of fibers. The moisture-retentive fabric medium may have the hydrophilic textile fiber comprises a natural or synthetic fiber.

In the water-absorbent fabric medium, hydrophilic fiber may be either a blend of synthetic and a natural fiber. At least 20% of the blend must be a synthetic polyester or copolyester as the hydrophilic content of the total fiber content of the water-absorbent fabric. Natural fibers include, without limitation, cotton, wool, hair, non-microfibrillated cellulose and the like. Additional synthetic hydrophilic fibers include, without limitation, polyamides, polyacrylates, polytrimethylene terephthalate, modacrylic, acrylic, polylactic acid fiber, cellulose acetate (and other chemically modified celluloses which make them textile fabrics), vinyl resin blends (but without sufficient soluble materials such as non-crosslinked polyvinyl alcohol so as to make the fiber soluble or dispersible when soaked in water at 50 C for ten minutes), modified polyolefins, and the like. A preferred material is an aromatic polyester such as tetramethylene terephthalate and the aliphatic polyether is alkylene ether glycol. Specifically, polybutylene terephthalate/polytetramethylene ether glycol block copolymer can be mentioned for instance. Specifically, a commercialized product is manufactured and marketed under the trade names, such as HYTREL™ (trade name, manufactured by E. I. du Pont de Nemours & Company (Inc.)). Formation of a nonwoven web from polyester elastomeric materials is disclosed in, for example, U.S. Pat. No. 4,741,949 to Morman et al.; and U.S. Pat. No. 4,707,398 to Boggs which are herein incorporated by reference. Other incorporated hydrophilic fiber-forming polymers are disclosed in U.S. Pat. Nos. 4,499,896; 4,598,004; and U.S. Pat. No. 5,849,325 (Heinecke et al.).

Hytrel™ 5526, as a non-limiting example, is a thermoplastic polyester elastomer. The Hytrel™ elastomer line covers a broad range of polyester elastomeric materials, especially the thermoplastic line which can be extruded into fibers according to the uses within the scope of the present invention. The thermoplastic line is used because of its range of available water-absorbency that can be used to make the blended fabric yarns useful for the specific functionalities of the present invention. The fibers should have an absorbency between 8-50% by total weight of the Hytrel™ fiber mass. The absorbency can be controlled by a balance of molecular weight (the higher the molecular weight, the lower the absorption amount) and by low level crosslinking (with insufficient crosslinking to prevent the polyester composition from being extruded into a fiber).

The shear rate of the Hytrel™ fibers are temperature reliant, and should be, at melt temperatures between 180 F-500 F, preferably between 190-280 F between 100 and 1000/sec.

Hytrel™ fibers may generically comprise a polyetherester (a subset within polyester or copolyester) may have a melt flow rate of from about 3.5 to 9.0 or 4.0 to about 7.0 grams per 10 minutes when measured in accordance with ASTM D-1238 at 190 degrees C. under a 2,160 gram load; a melting point of from about 275 degrees F. to about 425 degrees F. when measured in accordance with ASTM D-3418 (differential scanning calorimeter—peak of endotherm); a specific gravity of from about 1.10 to 1.20 when measured in accordance with ASTM D-792; a tensile stress at break (head speed 2 inches per minute) of from about 2,000 psi to about 4,250 psi when measured in accordance with ASTM D-638; an elongation at break of from about 200 percent to about 600 percent when measured in accordance with ASTM D-638 and a flexural modulus at 212 degrees F. of from about 3,500 psi to about 10,000 psi.

In actual examples, the 150/48 Hytrel® thermoplastic elastomer filament used is, by way of non-limiting example, Hytrel® 8206 (that is 150 total denier with 48 filaments of Hytrel® elastomer filaments in the cross-section of the yarn) was extruded and drawn with the total yarn bundle being 150 denier incorporating 48 filaments or 3.125 denier per filament. This yarn was wound onto a carrier package for storage and processing at a later date into a woven or knitted fabric. There also may be a combined den/filament range being between 0.2 to 6 den/filament.

The initial 115/136 elastomer/polyester used also included a structure this type of nomenclature is used to define standard description of a 115 total denier (in the yarn) with 136 filaments in the cross-section of the yarn) is a partially orientated micro-denier filament (POY) before processing, which indicates it as 115 total denier and 136 filaments or 0.845 denier per filament. At the texturizing machine the POY is stretched or ‘drawn’ down to 70 denier. This ratio of draw can be increased or decreased depending on the desired percentage of effect yarn required in the total fiber mass. After being drawn to desired size at the texturizing machine, the micro denier polyester filament is positioned and tensioned to be the ‘effect’ yarn during the actual Air Jet Texturizing process. This allows the micro-denier filament to intertwine with the core Hytrel® thermoplastic elastomeric polyester mixed blend yarn causing the micro denier effect yarn to be predominately on the surface of the exiting yarn bundle.

One preferred yarn product comprises Hytrel® 8026 (8206?) polyester 150 total denier 48 filaments 3.125 denier/filament with the interleaved non-elastomeric polyester having 70 total denier 136 filaments 0.514 denier/filament.

Aspects of the Current innovation include, by way of non-limiting example, a total denier of the yarn was 220 with 67.2% Hytrel/31.8% polyester with a resulting total den/filament being under 2 denier. Ranges of total denier/filament may range from about 0.20 to 5.0 denier/filament and provide significantly useful and unexpected results.

Additional and alternative products having the yarns provided with from 15%-85% of the Hytrel® (or equivalent) thermoplastic elastomer filaments and (especially air-textured) blended, intertwined, interleaved or otherwise enmeshed with other water-absorbent fibers up to 85%-15% of the total fiber content/filament content is useful, providing unique and varied products along the entire continuum of ratios. Part of the uniqueness is the absence of evidence in the prior art of the use of thermoplastic elastomeric polymers, including the polyesters and copolyesters as a basic filament structure in fabrics and yarns for providing highly efficient moisture-retention and moisture release fabric materials.

The Hytrel® thermoplastic elastomer or its equivalent could be extruded at a different total denier or the POY polyester could be drawn more or less to alter its percentage within the yarn bundle.

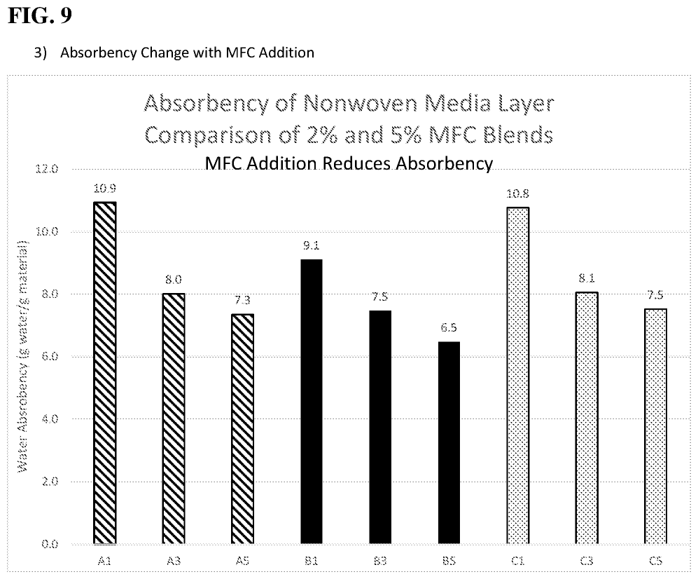

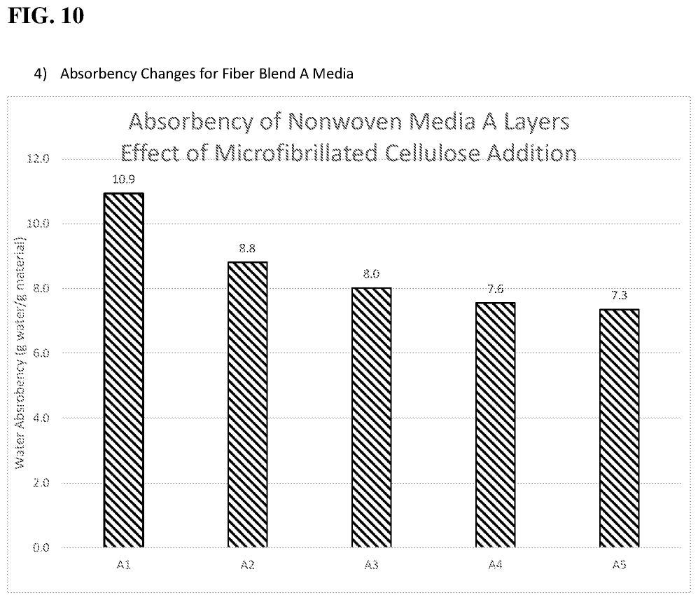

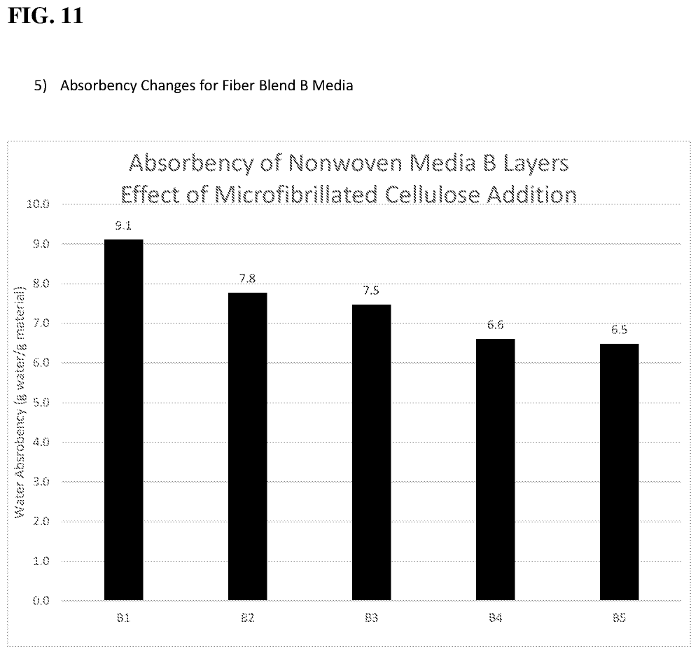

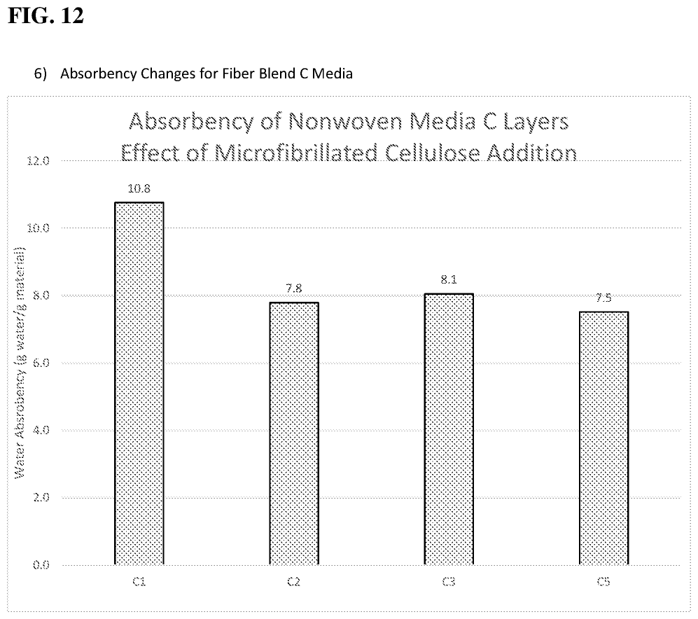

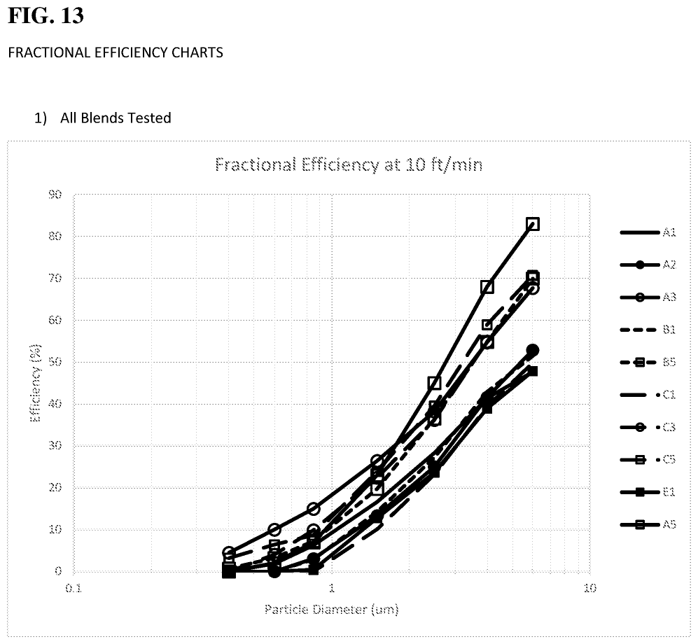

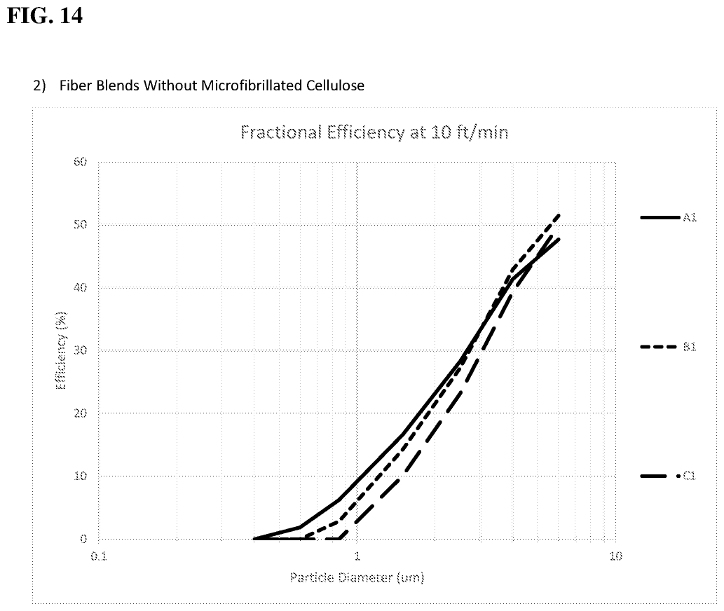

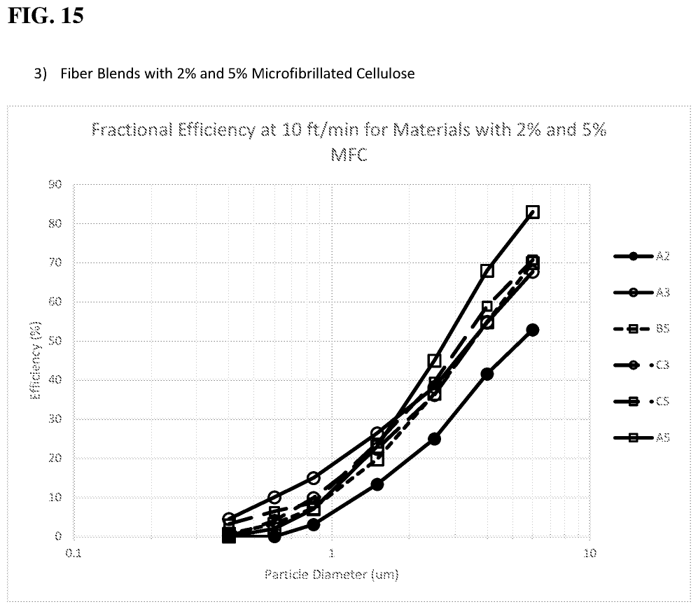

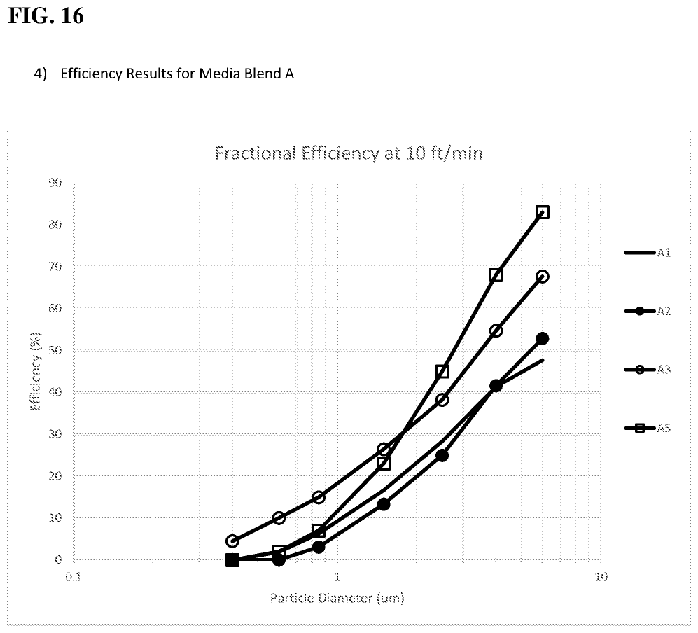

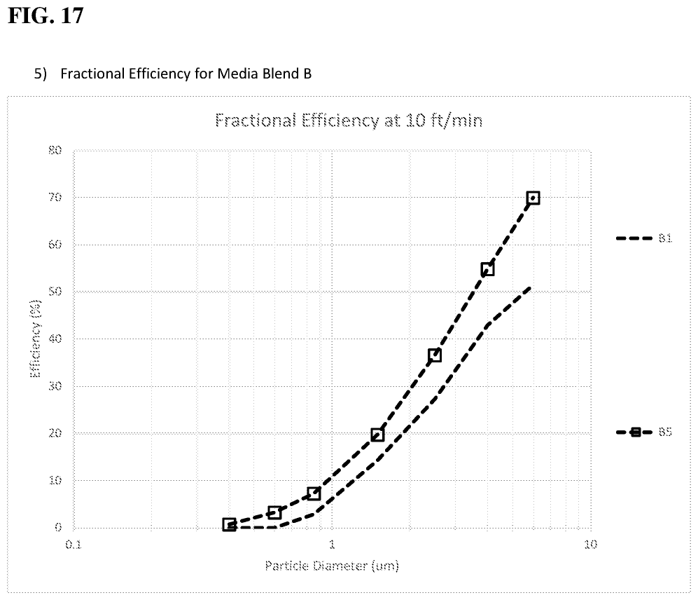

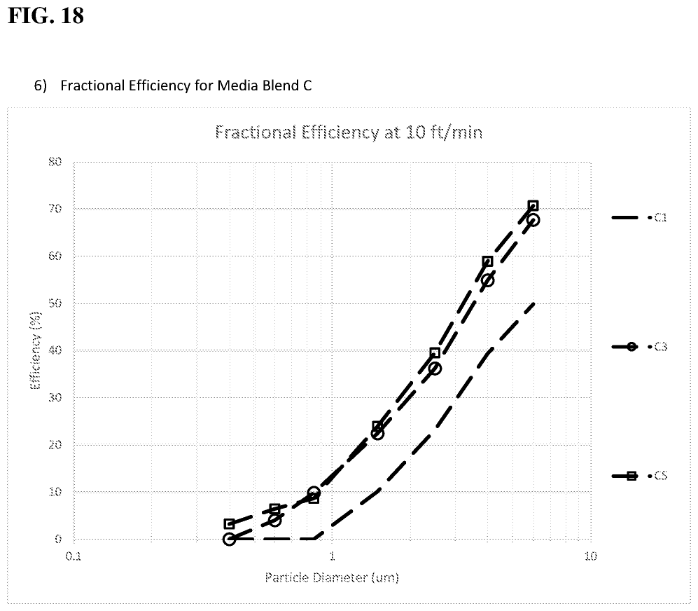

Current Air texturing technology generally does not incorporate staple or short cut fibers. The use of short length (e.g., 1-20 mm fibers in the air-texturing stream may itself be novel and unobvious to create a blend of filament/fibers without one of the fibers being extruded adjacent and/or contemporaneously with the thermoplastic elastomeric polyester core filament in the yarn. Previously, to make a core/sheath yarn incorporating cut fibers such as wool or cotton, one would have had to revert to ring or air jet spinning technology. Air-jet spinning is also known as Vortex or fasciated yarn spinning. It was introduced in the 1980s. A basic air-jet spinning system is shown in FIG. 9.12, Before the sliver from the draw-frame is supplied to the air-jet spinner, combing is often used, as it is imperative to get rid of any dust or trash that could obstruct the spinning jets. Twist is inserted to the fibers, mostly on the yarn surface, by the vortex created in one or two air-jet nozzles. The resulting yarn consists of a core of parallel fibers and a sheath of wrapped (twisted) fibers. The yarn produced by air jet spinning resembles a ring-spun yarn but is not as strong. The yarns are also inclined to shrink. High delivery rates of 150-450 m/min are possible with this technique.

Advantages of Air Jet Texturizing process in this innovation include at least:
bulks up the thermoplastic elastomeric filaments allowing for the Hytrel® filaments or equivalents to absorb and swell without the normal restrictions of tightly wound fibers or filaments. This increases the rate at which the total bulk of filaments will absorb water by exposing more surface area of the total mass of filaments.
allows the micro denier fibers/filaments with their large surface area to more easily transport moisture to and from the Hytrel® elastomeric filament core of the yarn.
provides a soft yarn/product with no torque that normally would be inherent with a spun yarn.

An important component of the fabric blends of the present invention is the use of thermoplastic polyester elastomers as a fibrous/filamentous component of a moisture-control fabric blend. This use of such thermoplastic polyester elastomer is far beyond traditional and advertised uses for such elastomers. For example, DuPont™ Hytrel® thermoplastic polyester elastomer (which class of elastomers includes Hytrl®2086) is advertised as Cable insulation and jacketing; chassis suspension Systems; Food Contact Materials; Innovative Furniture Design; Mechanical Gears; Medical Device Materials; Mobile Phone Housing &. Components; Plastics For Sporting Goods; Polymers for Oil and Gas; Railway Technology for the Long Haul; Seals and Gaskets; Sustainability in Airbag Systems; Thermoplastic Tubing and Elastomeric Hose. The elastomer is noted for its toughness and Resilience: Hytrel® flexes and recovers, providing excellent flex fatigue resistance, hysteresis and spring-like properties, in addition to exceptional toughness, impact resistance, and creep resistance. Over a Wide Temperature Range, it has Flexibility at low temperatures, and good retention of mechanical properties at high temperature. Resistance to Chemicals: Stands up to oils, fuels, hydrocarbon solvents, many other chemicals. It is able to be economical Processed: manufacturers can mold Hytrel® by injection, blow or rotational techniques; extrude it into tubes, profiles, fibers/filaments, sheet, blown or cast film, web coating, nonwovens, wire and cable jacketing.. Hytrel® has proven its performance in a wide variety of applications in automotive, electrical/electronic and various other industrial and consumer products. Some examples include: Auto parts and systems: CVJ boots, air intake ducting, air bag deployment doors, various components for heavy trucks and off-road equipment. Industrial products: Drive or idler belts, energy management parts, gears, hose and tubing, pump diaphragms, seals, shock and noise-absorbing connectors and fasteners, wire and cable jacketing. These characteristics are found in a DUPONT™ HYTREL® THERMOPLASTIC POLYESTER ELASTOMER PRODUCT REFERENCE GUIDE.

Hytrel® HTR8206 (having an alternative tradename as TPC-ET) was used consistently throughout this invention as an exemplary, but not exclusive, thermoplastic polyester elastomer.

Hytrel® HTR8206 is marketed a High-Performance Polyester Elastomer with High Moisture Vapor Transmission Rate Developed for Extrusion and Injection Molding. All of the following metrics apply to room temperature unless otherwise stated. SI units used unless otherwise stated. Equivalent standards are similar to one or more standards provided by the supplier. Some equivalent standards may be stricter whereas others may be outside the bounds of the original standard. Its general properties include a density at 23.0° C. of 1.19 g/cc and water absorption at 23.0° C. of 35% by weight. Its mechanical properties at 23.0° C. are an elastic modulus of 0.08 GPa, elongation of 420%, flexural modulus of 0.08 GPa, Shore Hardness D of 40, Poisons's ratio of o.49, tensile strength of 20 Moa, impact strength, Charpy notched and unnotched, no break, 179/IeA.

Its thermal properties are also those of an industrial strength component/manufacture materials such as melting point of 200° C., heat capacity of 2100 J/kg K), thermal diffusivity 0 mm²/g and Vicat softening temperature of 153° C. Its rheological properties likewise reflect good mechanical properties for manufacture of durable mechanical elements and components. It has a shrinkage of 1.4% (longitudinal and transverse).

Its technology properties include directions during processing methods of Drying Recommended: yes, Drying Temperature: 100° C., Drying Time, Dehumidified Dryer: 2-4 h, Processing Moisture Content: ≤0.08%, Melt Temperature Optimum: 230° C., Min. melt temperature: 220° C., Max. melt temperature: 240° C., Mold Temperature Optimum: 45° C., Min. mold temperature: 40° C., Max. mold temperature: 50° C.

DuPont® repeatedly markets this Hytrel® line as driving innovative design, enabling the development of unique parts with multiple performance characteristics. This versatile thermoplastic elastomer resin can flex in multiple directions, cycle after cycle, long after rubber would break. Its durability has made it an essential ingredient in automotive components such as the Constant Velocity Joint (CVJ) boot, which must endure an average of 150,000 miles of pounding over a wide range of temperatures.

The main thrust of even DuPont's® knowledge and marketing of Zo Hytrel® products, including specifically 8206, is that nothing in that background and evidence offers any hint of its utility as a fabric-dimensioned filament or fiber blended with other fabric materials would offer a unique capability as a moisture control fabric layer for personal, sports, medical and household uses.

As described in U.S. Pat. Nos. 8,586,159; 5,959,066; 5,958,581; 6,025,061; and 6,140,422, these thermoplastic polyester elastomers are typically identified and described as the copolyester is derived from an aliphatic glycol and at least two dicarboxylic acids, particularly aromatic dicarboxylic acids, preferably terephthalic acid and isophthalic acid. A preferred copolyester is derived from ethylene glycol, terephthalic acid and isophthalic acid. The preferred molar ratios of the terephthalic acid component to the isophthalic acid component are in the range of from 50:50 to 90:10, preferably in the range from 65:35 to 85:15. In a preferred embodiment, this copolyester is a copolyester of ethylene glycol with about 82 mole % terephthalate and about 18 mole % isophthalate. All patents, applications for patent and documents cited are incorporated by reference in their entirety.

The last of these U.S. patents claims the copolyesters as a polymer blend comprising (1) a polyester comprising terephthaloyl moieties and, optionally, other aromatic diacid moieties; ethylene glycol moieties; diethylene glycol moieties wherein said diethylene glycol moieties are present in an amount of at least about 0.25 mole % of the polyester; isosorbide moieties, and, optionally, one or more other diol moieties, wherein said polyester has an inherent viscosity of at least about 0.35 dL/g when measured as a 1% (weight/volume) solution of said polyester in o-chlorophenol at a temperature of 25.degree° C., and (2) another thermoplastic polymer. The another thermoplastic polymer is selected from the group consisting of polycarbonates, styrene resins, alkyl acrylate resins, polyurethane resins, vinyl chloride polymers, polyarylethers, copolyetheresters, polyhydroxyethers, polarylates, and other polyesters. The polymer blend may include the polyester as about 40% to about 50% terephthaloyl moieties and a total of up to about 10 mole % of one or more optional other aromatic diacid moieties. The terephthaloyl moieties are typically derived from terephthalic acid or dimethyl terephthalate. The ethylene glycol moieties are present in an amount of about 10 mole % to about 49.5 mole % of the polyester, said diethylene glycol moieties are present in the amount of about 0.25 mole % to about 10 mole % of the polyester, said isosorbide moieties are present in an amount of about 0.25 mole % to about 40 mole % of the polyester, and said one or more other diol moieties are present in an amount of up to about 15 mole % of the polyester. In the polymer blend, the one or more other diol moieties are derived from aliphatic alkylene glycols or branched aliphatic glycols having from 3-12 carbon atoms and having the empirical formula HO—CₙH₂ₙ—OH, where n is an integer from 3-12; cis or trans-1,4-cyclohexanedimethanol or mixtures thereof; triethylene glycol; 2,2-bis[4-(2-hydroxyethoxy)phenyl]propane; 1,1-bis[4-(2-hydroxyethoxy)-phenyl]cyclohexane; 9,9-bis[4-(2-hydroxyethoxy)phenyl]fluorene; 1,4:3,6-dianhydromannitol; 1,4:3,6-dianhydroiditol; or 1,4-anhydroerythritol.

In an alternative embodiment, hereinafter referred to as Embodiment B2, the copolyester may be derived from an aliphatic diol and a cycloaliphatic diol with one or more, preferably one, dicarboxylic acid(s), preferably an aromatic dicarboxylic acid. Examples include copolyesters of terephthalic acid with an aliphatic diol and a cycloaliphatic diol, especially ethylene glycol and 1,4-cyclohexanedimethanol. The preferred molar ratios of the cycloaliphatic diol to the aliphatic diol are in the range from 10:90 to 60:40, preferably in the range from 20:80 to 40:60, and more preferably from 30:70 to 35:65. In a preferred embodiment this copolyester is a copolyester of terephthalic acid with about 33 mole % 1,4-cyclohexane dimethanol and about 67 mole % ethylene glycol. An example of such a polymer is PETG™6763 (Eastman) which comprises a copolyester of terephthalic acid, about 33% 1,4-cyclohexane dimethanol and about 67% ethylene glycol and which is always amorphous. In an alternative embodiment of the invention, the polymer of layer B may comprise butane diol in place of ethylene glycol.

In a further alternative embodiment, an additional heat-sealable layer comprises an aromatic dicarboxylic acid and an aliphatic dicarboxylic acid. A preferred aromatic dicarboxylic acid is terephthalic acid. Preferred aliphatic dicarboxylic acids are selected from sebacic acid, adipic acid and azelaic acid. The concentration of the aromatic dicarboxylic acid present in the copolyester is preferably in the range from 45 to 80, more preferably 50 to 70, and particularly 55 to 65 mole % based on the dicarboxylic acid components of the copolyester. The concentration of the aliphatic dicarboxylic acid present in the copolyester is preferably in the range from 20 to 55, more preferably 30 to 50, and particularly 35 to 45 mole % based on the dicarboxylic acid components of the copolyester. Particularly preferred examples of such copolyesters are (i) copolyesters of azeleic acid and terephthalic acid with an aliphatic glycol, preferably ethylene glycol; (ii) copolyesters of adipic acid and terephthalic acid with an aliphatic glycol, preferably ethylene glycol; and (iii) copolyesters of sebacic acid and terephthalic acid with an aliphatic glycol, preferably butylene glycol. Preferred polymers include a copolyester of sebacic acid/terephthalic acid/butylene glycol (preferably having the components in the relative molar ratios of 45-55/55-45/100, more preferably 50/50/100) having a glass transition point (T_{g}) of −40° C. and a melting point (Tₘ) of 117° C.), and a copolyester of azeleic acid/terephthalic acid/ethylene glycol (preferably having the components in the relative molar ratios of 40-50/60-50/100, more preferably 45/55/100) having a T_{g} of −15° C. and a Tₘ of 150° C.

In a further alternative embodiment, hereinafter referred to as Embodiment B4, the additional heat-sealable layer comprises an ethylene vinyl acetate (EVA). Suitable EVA polymers may be obtained from DuPont as Elvax™ resins. Typically, these resins have a vinyl acetate content in the range of 9% to 40%, and typically 15% to 30%.

Formation of the filaments may be effected by conventional techniques well-known in the art. Conveniently, formation of the substrate is effected by extrusion, in accordance with the procedure described below. In general terms the process comprises the steps of extruding a filament of molten polymer, quenching the extrudate and orienting the quenched extrudate in at least one direction.

The Hytrel® thermoplastic elastomeric filament may be uniaxially oriented, but is preferably biaxially oriented by drawing or rotating during extrusion in two mutually perpendicular directions in the plane of the film to achieve a satisfactory combination of mechanical and physical properties. Orientation may be effected by any process known in the art for producing an oriented film, for example a tubular or flat film process.

In one preferred process, the filament-forming polyester is extruded through a slot die and rapidly quenched upon a chilled casting drum to ensure that the polyester is quenched to the amorphous state. Orientation is then effected by stretching the quenched extrudate in at least one direction at a temperature above the glass transition temperature of the polyester. Sequential orientation may be effected by stretching a circular diameter, quenched extrudate firstly in one direction, usually the longitudinal direction, i.e., the forward direction through the film stretching machine, and then in the transverse direction. Forward stretching of the extrudate is conveniently effected over a set of rotating rolls or between two pairs of nip rolls, transverse stretching then being effected in a stenter apparatus. Alternatively, the cast filament may be stretched simultaneously in both the forward and transverse directions in a biaxial stenter. Stretching is effected to an extent determined by the nature of the polyester, for example polyethylene terephthalate is usually stretched so that the dimension of the oriented film is from 2 to 5, more preferably 2.5 to 4.5 times its original dimension in the or each direction of stretching. Typically, stretching is effected at temperatures in the range of 70 to 125° C. Greater draw ratios (for example, up to about 8 times) may be used if orientation in only one direction is required. It is not necessary to stretch equally in the machine and transverse directions although this is preferred if balanced properties are desired.

A stretched film may be, and preferably is, dimensionally stabilized by heat-setting under dimensional restraint at a temperature above the glass transition temperature of the polyester but below the melting temperature thereof, to induce crystallization of the polyester. In applications where film shrinkage is not of significant concern, the film may be heat set at relatively low temperatures or not at all. On the other hand, as the temperature at which the film is heat set is increased, the tear resistance of the film may change. Thus, the actual heat set temperature and time will vary depending on the composition of the film but should not be selected so as to substantially degrade the tear resistant properties of the film. Within these constraints, a heat set temperature of about 135° to 250° C. is generally desirable, as described in GB-A-838708.

Conveniently, formation of an additional associated filament/fiber and the filament is effected by coextrusion, which would be suitable for Embodiments B1 and B2 above. Other methods of forming the additional filament/fiber layer include coating the heat-sealable polymer onto the additional filament/fiber mass substrate, and this technique would be suitable for Embodiments B3 and B4 above. Coating of materials onto the filament, yarn or fabric may be effected using any suitable coating technique, including gravure roll coating, reverse roll coating, dip coating, bead coating, extrusion-coating, melt-coating or electrostatic spray coating. Coating may be conducted “off-line,” i.e., after any stretching and subsequent heat-setting employed during manufacture of the filament, or “in-line”, i.e., wherein the coating step takes place before, during or between any stretching operation(s) employed. Preferably, coating is performed in-line, and preferably between the forward, rotational and sideways stretches of a biaxial stretching operation (“inter-draw” coating). Examples of the coating of layers include: GB-2024715 and GB-1077813 which disclose the inter-draw extrusion-coating of polyolefin onto substrates of polyolefin and polyester respectively; U.S. Pat. No. 4,333,968 which discloses the inter-draw extrusion-coating of an ethylene-vinyl acetate copolymer onto a polypropylene substrate; and WO-02/59186 which discloses the coating of copolyester, and the disclosures of these documents are incorporated herein by reference.

Prior to application of an additional filament/fiber onto the substrate, the exposed surface of the Hytrl® filament may, if desired, be subjected to a chemical or physical surface-modifying treatment to improve the bond between that surface and the subsequently applied layer. For example, the exposed surface of the substrate may be subjected to a high voltage electrical stress accompanied by corona discharge or pulsed laser. Alternatively, the Hytrel® filament substrate may be pretreated with an agent known in the art to have a solvent or swelling action on the substrate, such as a halogenated phenol dissolved in a common organic solvent e.g. a solution of p-chloro-m-cresol, 2,4-dichlorophenol, 2,4,5- or 2,4,6-trichlorophenol or 4-chlororesorcinol in acetone or methanol.

The substrate is suitably of a thickness between about 5 μm to 0.6 cm, or 10 μm to 0.5 cm, or as small as 0.35 mm, preferably from 9 μm to about 0.150 mm and particularly from about 12 μm to about 0.40 mm.

Perforation or surface texturing of the substrate and, if present, the additional filament/fiber component may be effected using an Intermittent Hot Needle Perforator (PX9 series; BPM Engineering Services Ltd, Rochdale, UK). The lower diameter limit for perforations made in this way is generally about 0.1 mm. Perforations may also be effected by a laser beam (for example a CO₂ laser) in which case, perforations of smaller diameter can be made, typically down to about 0.05 mm. Perforations are typically made in one or more lines across the yarn or fabric. Any suitable arrangement for the hole pattern may be adopted. For instance, the holes may be arranged in a cubic close-packed arrangement or a hexagonal close-packed arrangement. Preferably all perforations have the same or substantially the same diameter.

The filament-forming materials are typically insoluble or substantially insoluble in water. Solubility is measured as the fraction of the barrier layer dissolved when the film is immersed in deionised water at 80° C. for 2 minutes. Thus, in the case of a completely water insoluble barrier layer, the mass fraction of layer dissolved is 0. It is preferred that the mass fraction of barrier layer dissolved is no more than 0.2, preferably no more than 0.1, preferably no more than 0.05, preferably no more than 0.01, and preferably 0.

Suitable polymeric materials as the additional filament/fiber are selected from polyesters; copolyesterethers; polyolefins; styrenic thermoplastic elastomers (including styrene-butadiene-styrene (SBS), styrene-isoprene-styrene (SIS), styrene-ethylene-butylene-styrene (SEBS) and styrene-ethylene-propylene-styrene (SEPS)); copolyamideethers (particularly polyether block amides); polyamides (including nylon 4, 6, 6/6, 6/10, 6/12, 11 and 12); cellulosic plastics (including cellulose and cellulose derivatives such as cellulose acetate and cellulose propionate); polycaprolactone; and polyurethane (including Estane(RO polymer).

An adjacent polyester filament/fiber is preferably a synthetic linear polyester selected from those mentioned herein above, particularly a polyester derived from one dicarboxylic acid, preferably an aromatic dicarboxylic acid, preferably terephthalic acid or naphthalenedicarboxylic acid, more preferably terephthalic acid, and one glycol, particularly an aliphatic or cycloaliphatic glycol, preferably ethylene glycol. Preferably, the unperforated polyester layer comprises PET.

An unperforated copolyesterether layer may comprise, for instance, a copolyesterether as described in U.S. Pat. No. 4,725,481, the disclosure of which copolyesterethers is incorporated herein by reference.

In a preferred embodiment, the copolyetherester elastomer(s) have a multiplicity of recurring long-chain ester units and short-chain ester units joined head-to-tail through ester linkages, said long-chain ester units being represented by the formula:

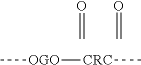

and said short-chain units being represented by the formula:

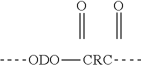

wherein G is a divalent radical remaining after the removal of terminal hydroxyl groups from a poly(alkylene oxide)glycol having an average molecular weight of about 400 to 4000, preferably, about 400 to 3500, wherein the amount of ethylene oxide groups incorporated in said one or more copolyetheresters by the poly(alkylene oxide)glycol is from about 20 to about 68 weight percent, preferably from about 25 to about 68 weight percent, based upon the total weight of the copolyetherester(s); R is a divalent radical remaining after removal of carboxyl groups from a dicarboxylic acid having a molecular weight less than about 300; D is a divalent radical remaining after removal of hydroxyl groups from a diol having a molecular weight less than about 250; wherein said copolyetherester(s) contain from about 25 to about 80 weight percent short-chain ester units.

As an exception to other uses of blended fibers, the moisture adjusting when also used as a gas filtering medium should not have much if any (less than 1.0/100 parts by weight of total textile fibers) microfibrillated cellulose include a cellulose particle, fiber or fibril with at least one dimension less than 500 nm.

As used herein, the term “nanofibrillar cellulose” or nanofibrillar cellulose or NFC is understood to encompass nanofibrillar structures released from cellulose pulp. The nomenclature relating to nanofibrillar celluloses is not uniform and there is an inconsistent use of terms in the literature. For example, the following terms have been used as synonyms for nanofibrillar cellulose (NFC): cellulose nanofiber, nanofibril cellulose (CNF), nano-scale fibrillated cellulose, microfibrillar cellulose, cellulose microfibrils, microfibrillated cellulose (MFC), and fibril cellulose. The smallest cellulosic entities of cellulose pulp of plant origin, such as wood, include cellulose molecules, elementary fibrils, and microfibrils. Microfibril units are bundles of elementary fibrils caused by physically conditioned coalescence as a mechanism of reducing the free energy of the surfaces. Their diameters vary depending on the source. The term “nanofibrillar cellulose” or NFC refers to a collection of cellulose nanofibrils liberated from cellulose pulp, particularly from the microfibril units. Nanofibrils have typically high aspect ratio: the length exceeds one micrometer while the diameter is typically below 100 nm. The smallest nanofibrils are similar to the so-called elementary fibrils. The dimensions of the liberated nanofibrils or nanofibril bundles are dependent on raw material, any pretreatments and disintegration method. Intact, unfibrillated microfibril units may be present in the nanofibrillar cellulose but only in small or even insignificant amounts.

Microfibrillated cellulose (MFC) shall in the context of the patent application mean a nano-micro scale cellulose particle fiber or fibril with at least one dimension less than 500 nm, or less than 250 nm or less than 100 nm. Other dimensions may be up to 1500 nm or more. MFC comprises partly or totally fibrillated cellulose or lignocellulose fibers. The liberated fibrils have a diameter less than the 50 nm, 250 nm or 100 nm, whereas the actual fibril diameter or particle size distribution and/or aspect ratio (length/width) depends on the source and the manufacturing methods.

Fiber and textile technology have a number of features and parameters that tend to be unique to those fields.

### PROPERTIES Denier

Denier is a property that varies depending on the fiber type. It is defined as the weight in grams of 9,000 meters of fiber. The current standard of denier is 0.05 grams per 450 meters. Yarn is usually made up of numerous filaments. The denier of the yarn divided by its number of filaments is the denier per filament (dpf). Thus, denier per filament is a method of expressing the diameter of a fiber. Obviously, the smaller the denier per filament, the more filaments there are in the yarn. If a fairly closed, tight web is desired, then lower dpf fibers (1.5 or 3.0) are preferred. On the other hand, if high porosity is desired in the web, a larger dpf fiber—perhaps 6.0 or 12.0—should be chosen. Here are the formulas for converting denier into microns, mils, or decitex: Diameter in microns=11.89×(denier/density in grams per milliliter)1/2 Diameter in mils=diameter in microns×0.03937 Decitex=denier×1.1.

Length—The length of the preferred fiber is directly related to the diameter. This is referred to as the aspect ratio. Aspect ratio is found by dividing the length of the fiber by the diameter (using the same unit of measure for each). The ideal aspect ratio is 500:1. An example follows: Length=250 mils Diameter=0.491 mils L/D=250/0.491=509 When the correct aspect ratio is used, you receive an optimum amount of strength, as well as good dispersion. As the aspect ratio increases, the fiber becomes more difficult to disperse; as it decreases, there is a loss of strength resulting from poor binding capability. End Condition Diameter and length are both very important factors, but if there is a poor end condition on cut fiber, all has been in vain. Some product are referred to as precision-cut fiber—fiber in which all ends are squarely cut and not fused together. Filament and fiber are loosely and overlappingly used to describe longer and shorter elements are not in themselves highly technical and precise terms.

The smallest fibril is called elementary fibril and has a diameter of approximately 2-4 nm (see e.g., Chinga-Carrasco, G., Cellulose fibers, nanofibrils and microfibrils. The morphological sequence of MFC components from a plant physiology and fiber technology point of view, Nanoscale research letters 2011, 6:417), while it is common that the aggregated form of the elementary fibrils, also defined as microfibril (Fengel, D., Ultrastructural behavior of cell wall polysaccharides, Tappi J., March 1970, Vol 53, No. 3.), is the main product that is obtained when making MFC e.g., by using an extended refining process or pressure-drop disintegration process. Depending on the source and the manufacturing process, the length of the fibrils can vary from around 1 to more than 10 micrometers. A coarse MFC grade might contain a substantial fraction of fibrillated fibers, i.e., protruding fibrils from the tracheid (cellulose fiber), and with a certain amount of fibrils liberated from the tracheid (cellulose fiber).

Each document and formal published ASTM procedure or test cited herein is incorporated by reference in its entirety.

One concept in the trial of various fiber blends was to manufacture blended yarns or twisted fibers according to standard fabric manufacturing methods. When an antimicrobial was used, we provided a silver-based antimicrobial, Lurol® AG-1500 from Goulston Technologies, supplied as a liquid emulsion. The emulsion was diluted 50% with water before applying to the hand-sheet samples. The target loading for the Ag-1500 was 10% by weight.

To measure absorbency and moisture retention, 1-in×2-in samples of each woven or knitted fabric (as hand-sheets) were initially weighed and then immersed in water for 60 seconds and allowed to dry in air at room temperature and 70% RH for 60 seconds. After 60 seconds of drying, the samples were weighed to determine the amount of water they absorbed; this amount was recorded as the absorbency. Samples were allowed to continue drying and were weighed over time to determine the amount of water they retained. Three samples from each handsheet were used for the tests.

Fractional efficiency testing was performed on selected hand-sheets by LMS Technologies of Bloomington, Minn. The testing used neutralized sodium chloride particles with particles diameters ranging from 0.3-10 microns. Testing was performed at 71° F. and 50% RH at an air flow rate of 10 ft/min. The testing used 10-in×10-in hand-sheet samples.

### Results of Manufacture and Measurements:

### Absorbency and Retention:

This desirable set of properties was met with several blends. Absorbency and moisture retention results showed that the fiber blend materials made at the trial had similar performance to the absorbency and moisture retention properties of the superabsorbent fiber air-laid materials made according to the Gray patent cited above several years ago.

The results show that absorbency is not only affected by the type of fiber used in the media, but also by the fiber structure in the filter media.

The attached tables show the results for absorbency and moisture retention, shown for non-woven fabrics. However, as this is a physical phenomenon, the data should transfer in parallel to woven and knitted fabrics from yarns with the same mass density/square-meter of fabric. Charts provided show the absorbency and retention properties for the different fiber blends. The charts also show the effect of adding microfibrillated cellulose to the fiber blend during the manufacturing process. Surprisingly, the microfibrillated cellulose did not increase absorbency or moisture retention for the fiber blends although it did significantly increase filtration efficiency, as well as tensile and stiffness properties of all the samples. Therefore, the microfibrillated cellulose is not part of the present invention.

Another advantage of the new blends is that any added antimicrobial coating (gel, liquid or aqueous-activated solid) or antiviral coating was able to be applied during the media manufacturing process. Manufacturing costs for the coated media can be reduced significantly if the coating can be applied during the media manufacturing process rather than in a separate manufacturing process step.

The present invention also exhibits structural and functional improvements over the use of superabsorbent polymers in the fabric blends, especially with any more than 0.05%/weight of superabsorbent polymers as described in U.S. Pat. No. 9,901,128 (Gray) which describes an apparel or material which may be placed anywhere or worn about the neck or other parts of the body of a human. The apparel/material has a structure that, when repositioned from about the wearer, will retain a position about a mouth and nose of the human, as by elasticity or taughtness of a wrapping about the face. The apparel is sufficiently porous as to allow a human to breath comfortably through the fabric when placed over the mouth and nose of the human. The fabric has as a coating is created with on at least the outer surface and through at least 25% of the thickness of the fabric a moisture-sensitive antimicrobial composition, wherein the antimicrobial moisture-sensitive composition comprises an antimicrobially active compound and a carrier, the carrier by hydrophilic and able to absorb sufficient moisture from exhaled breath from the human as to maintain a wet surface on the carrier to which viral particles will adhere more strongly than to a dry surface of the same carrier.

All the blends manufactured in the trial were able to be coated or imbibed with the antiviral coating. The media blends made during the trial are also more wettable than the previous superabsorbent fiber media, so they can absorb any liquid faster and keep any liquid droplets from remaining on the surface for any length of time.

### Secondary Considerations

The blended fabric material has advantages in the personal protection (facemask) as well as industrial filtration applications and can perform well as sports fabric for exercising and competition, absorbing perspiration without becoming water-logged (as would superabsorbent polymers) and without losing its open-pore, air-flow enabling porosity. This allows for greater comfort to the user during hard exercise. The superabsorbent fiber nonwovens in previous application had low filtration efficiencies and were relatively thick. Essentially, a functionally desirable replacement for superabsorbent fiber media was found that provides more options to supply competitive media for a variety of applications. Although the degree of water-absorbency does not exceed the water-absorbency of media with a high percentage of superabsorbent fiber, other more critical properties such as porosoity under moist conditions and retention of physical endurance properties under wet conditions can be provided.

Methods of manufacturing yarns are well known with fiber blends and are taught for example in U.S. Pat. No. 10,240,283 (Gupta), evidencing spinning a blended feed material into a blended yarn, (iii) producing a fabric comprising the blended yarn; U.S. Pat. No. 7,005,093 (Ding); U.S. Pat. No. 6,653,250 (Driggars); U.S. Pat. No. 5,417,048 (Thomas); and U.S. Pat. No. 5,155,989 (Frey). Twisted fiber yarns are also known in the prior art, and there are numerous methods of manufacture known, such as U.S. Pat. No. 8,926,933 (Zhang) and U.S. Pat. No. 4,898,642 (Moore). These patents are incorporated by reference in their entireties to enable manufacture of blended yarns according to the present invention.

### Results

Media blends made during the trial can be manufactured using a wet-laid process, which will make them less expensive to produce in large volumes. In addition, the media blends made during the trial also have the following advantages:

The properties of these fabrics are evidenced in the attached tables provided as Figures.

In addition, compared to the prior superabsorbent fiber media, the media blends tested were able to achieve higher filtration efficiencies with significantly lower pressure drop. This result means that a facemask or other product can be manufactured with the new blends which will provide better breathability and better efficiency. Because the materials are thin and the pressure drop across them is low, if higher efficiency is desired, additional layers of the material can be used while the overall product can still retain good breathability.

Quality Factor is a comparison used to rank filter media based on their relative efficiency and pressure drop; it is an attempt to recognize that higher efficiency at a low-pressure drop is more desirable than high efficiency at a high pressure drop. As seen in the efficiency spreadsheet, the quality factors for the new blends of media are significantly higher than the quality factors for the previous superabsorbent media, in some cases an order of magnitude higher.
Media blends can likely be pleated and corrugated, which can be necessary for some filtration applications. Pleating a media allows one to pack more filter media into a filter, which will increase the amount of surface area available for filtration and increase the efficiency and overall holding-capacity of the filter product. Even with an additional layer of fine fiber media (such as meltblown, electrospun, microcellulose, or other fibers with diameters less than 2.0 micron) added for high efficiency, the media will still be able to be pleated. Corrugations increase stiffness and provide self-spacing for tightly pleated media, which allows for use in many filter applications.

Ultrasonic and thermal bonding capability.

1) The media blends can be ultrasonically bonded or thermally bonded—particularly the A and C blends with >50% synthetic fiber. These types of bonding methods provide an advantage in both cost and performance over filter media that need an adhesive resin in order to bond. Because the media will not require an adhesive bond, they can be laminated with less cost and also have more open pores available for storing contaminants and allowing for higher air flow; adhesive resin will plug pores to some extent.

Surprising Results
1) In combination with the microfibrillated Cellulose (NFC) fibers, absorbency and moisture retention were often higher in the blends that had >50% (up to 80%) by total weight of textile hydrophobic fibers (A and C blends) than they were in blends that had >50% hydrophilic fibers (up to 70% by textile fiber weight, as in the B and F blends). This result was consistent across all levels of MFC loading as well.
2) The addition of microfibrillated cellulose actually decreased the absorbency and did not increase the moisture retention of the material. Microfibrillated cellulose is often used to increase moisture retention in several applications; it also has an initial absorbency of >10 g water/g in most literature reviewed. The particular fiber media structure may have impacted the effect of the microfibrillated cellulose; the antiviral coating may have played a role as well. However, the blends without MFC still have sufficient absorbency and moisture retention for many medical applications and also provide large benefits in efficiency, tensile strength, and stiffness.

It is also been found that stiffness and tensile strength can increase from the MFC addition, and that property will be significant. In forming (molding, corrugating, bending, cutting and fitting), the increase in tensile strength increases useful life of the materials often caused by these structural processes performed on the media.

The invention includes a moisture retentive fabric comprising 10-90% or 20-80% by total weight of fibers as a thermoplastic elastomeric copolyester derived from aliphatic alkylene glycols or branched aliphatic glycols having from 3-12 carbon atoms and having the empirical formula HO—CₙH₂ₙ—OH, where n is an integer from 3-12; cis or trans-1,4-cyclohexanedimethanol or mixtures thereof; triethylene glycol; 2,2-bis[4-(2-hydroxyethoxy)phenyl]propane; 1,1-bis[4-(2-hydroxyethoxy)-phenyl]cyclohexane; 9,9-bis[4-(2-hydroxyethoxy)phenyl]fluorene; 1,4:3,6-dianhydromannitol; 1,4:3,6-dianhydroiditol; or 1,4-anhydroerythritol, and the copolyester fibers are blended with a second fiber comprising 90-10% or 80-20% by total weight of fibers as hydrophilic textile fibers which hydrophilic textile fibers absorb at least 15% by weight but less than 100% by weight of the hydrophilic textile fiber, preferably less than 50% by weight of the hydrophilic textile fiber. The moisture retentive fabric may have the hydrophilic fibers selected from the group consisting of cotton, wool, non-elastomeric polyester, polyacrylates, cellulose fibers, cellulose acetate (e.g., viscose), and nylon.

A method of manufacturing thee fabric materials includes a method of manufacturing a yarn of the moisture-retentive fabric medium of claim 1 comprising extruding multiple first hydrophilic, thermoplastic elastomeric polyester fibers, air texturing the first hydrophilic elastomeric fibers and during air texturing, comingling the first fibers into a blend of from 10-90% or 20-80% by total weight of the thermoplastic elastomeric polyester textile fibers and a second, different composition hydrophilic fiber completing the majority of the remaining weight of the yarn. Multiple second, different composition hydrophilic fibers may be used.

What is claimed:

1. A moisture-retentive fabric medium comprising a first hydrophilic, thermoplastic elastomeric polyester fiber as a blend of from 10-90% by total weight of the thermoplastic elastomeric polyester textile fibers and a second fiber comprising 90-10% by total weight of hydrophilic textile fibers, the thermoplastic elastomeric polyester fiber having a melting point between 190-500 F when measured in accordance with ASTM D-3418.

2. The moisture-retentive fabric medium of claim 1 further characterized both as having less than 0.5% by weight of total fabric medium as microfibrillated cellulose fiber and also having less than 0.05% by weight superabsorbent polymers.

3. The moisture-retentive fabric medium of claim 2 wherein the polyester comprises a polyetherester polyester.

4. The moisture retentive fabric medium of claim 2 wherein the polyester has a melt flow rate of from 3.5 to 9.0 grams per 10 minutes when measured in accordance with ASTM D-1238 at 190 degrees C. under a 2,160 gram load and a melting point of from 275 degrees F. to 425 degrees F. when measured in accordance with ASTM D-3418; a specific gravity of from about 1.10 to 1.20 when measured in accordance with ASTM D-792; and a tensile stress at break, with a head speed 2 inches per minute of from 1,800 psi to about 4,500 psi when measured in accordance with ASTM D-638.

5. The moisture-retentive fabric medium of claim 4 having an elongation at break of from 200 percent to 600 percent when measured in accordance with ASTM D-638 and a flexural modulus at 212 degrees F. of about 3,500 psi to 10,000 psi.

6. The moisture-retentive fabric medium of claim 2 wherein the medium comprises a yarn consisting essentially of the blend of fibers.

7. The moisture-retentive fabric medium of claim 3 wherein the medium comprises a yarn consisting essentially of the blend of fibers.

8. The moisture-retentive fabric medium of claim 3 wherein the non-woven fabric is a wet-laid non-woven fabric.

9. The moisture-retentive fabric medium of claim 3 wherein the medium comprises a yarn consisting essentially of the blend of fibers.

10. The moisture-retentive fabric medium of claim 4 wherein the hydrophilic textile fiber comprises a natural fiber.

11. The moisture-retentive fabric medium of claim 3 wherein the hydrophilic textile fiber comprises a synthetic fiber.

12. The moisture-retentive fabric medium of claim 4 wherein the medium is free of any microfibrillated cellulose and free of any superabsorbent polymer.

13. The moisture-retentive fabric medium of claim 3 wherein the polyester comprises a polybutylene terephthalate/polytetramethylene ether glycol block copolymer.

14. The moisture-retentive fabric medium of claim 4 wherein the polyester comprises a polybutylene terephthalate/polytetramethylene ether glycol block copolymer.

15. The moisture-retentive fabric medium of claim 11 wherein the polyester comprises a polybutylene terephthalate/polytetramethylene ether glycol block copolymer.

16. A moisture retentive fabric comprising 10-90% by total weight of fibers as a water-absorbent thermoplastic elastomeric copolyester derived from aliphatic alkylene glycols or branched aliphatic glycols and having a water absorption of 15-0% by weight of the copolyester, and the copolyester fibers are blended with a second fiber comprising 90-10% by total weight of fibers as hydrophilic textile fibers.

17. The moisture retentive fabric of claim 16 comprising 20-80% by total weight of fibers as a thermoplastic elastomeric copolyester derived from aliphatic alkylene glycols or branched aliphatic glycols having from 3-12 carbon atoms and having the empirical formula HO—CₙH₂ₙ—OH, where n is an integer from 3-12; cis or trans-1,4-cyclohexanedimethanol or mixtures thereof; triethylene glycol; 2,2-bis[4-(2-hydroxyethoxy)phenyl]propane; 1,1-bis[4-(2-hydroxyethoxy)-phenyl]cyclohexane; 9,9-bis[4-(2-hydroxyethoxy)phenyl]fluorene; 1,4:3,6-dianhydromannitol; 1,4:3,6-dianhydroiditol; or 1,4-anhydroerythritol, and the copolyester fibers are blended with a second fiber comprising 80-20% by total weight of fibers as hydrophilic textile fibers.

18. The moisture retentive fabric of claim 17 wherein the hydrophilic fibers are selected from the group consisting of cotton, wool, non-elastomeric polyester, polyacrylates, cellulose fibers, cellulose acetate, and nylon.

19. The moisture retentive fabric of claim 16 wherein the thermoplastic elastomeric copolyester and the second fiber have been air textured to form a single filament or fiber having a range of total denier between 0.20 and 5.0.

20. The moisture retentive fabric of claim 17 wherein the thermoplastic elastomeric copolyester and the second fiber have been air textured to form a single filament or fiber having a range of total denier between 50 denier and 3500 total denier of the fibrous mass.

21. The moisture retentive fabric of claim 18 wherein the thermoplastic elastomeric copolyester and the second fiber have been air textured to form a single filament or fiber having a range of total denier between 50 denier and 3500 total denier of the fibrous mass.

22. The moisture retentive fabric medium of claim 21 wherein the thermoplastic elastomeric copolyester has a melt flow rate of from 3.5 to 9.0 grams per 10 minutes when measured in accordance with ASTM D-1238 at 190 degrees C. under a 2,160 gram load and a melting point of from 275 degrees F. to 425 degrees F. when measured in accordance with ASTM D-3418; a specific gravity of from about 1.10 to 1.20 when measured in accordance with ASTM D-792; and a tensile stress at break, with a head speed 2 inches per minute of from 1,800 psi to about 4,500 psi when measured in accordance with ASTM D-638.

23. A method of manufacturing a yarn of the moisture-retentive fabric medium of claim 1 comprising extruding multiple first hydrophilic, thermoplastic elastomeric polyester fibers, air texturing the first hydrophilic elastomeric fibers and during air texturing, comingling the first fibers into a blend of from 10-90% by total weight of the thermoplastic elastomeric polyester textile fibers and a second, different composition hydrophilic fiber.

24. The moisture-retentive fabric medium of claim 3 wherein the non-woven fabric is an air-laid non-woven fabric.
